(19) United States
(12) Patent Application Publication
(10) Pub. No.: US 2025/0313449 A1
(43) Pub. Date: Oct. 9, 2025

(54) Beer Tap Socket

(71) Applicant: Justin Gillespie, Largo, IN (US)

(72) Inventor: Justin Gillespie, Largo, IN (US)

(21) Appl. No.: 19/173,040

(22) Filed: Apr. 8, 2025

Related U.S. Application Data
(60) Provisional application No. 63/631,703, filed on Apr. 9, 2024.

(51) Int. Cl. B67D 1/14

(52) U.S. Cl. CPC B67D 1/1405; B67D 2210/00062

(57) ABSTRACT

A tap socket configured to engage and tighten a nut installed on a fluid tube shank installed on a tap rail is provided. The tap socket includes a body, a cavity, a slot, and a first opening. The cavity is located within the body. The slot extends from an exterior of the body to the cavity. The first opening is located in the body. The first opening is in communication with the cavity. At least a portion of a periphery of the cavity defines a plurality of facets. The slot is configured to receive at least a portion of the fluid tube shank. The plurality of facets is configured to correspond to a plurality of wall surfaces on the nut.

### RELATED APPLICATIONS

The present Application relates to and claims priority to U.S. Provisional Patent Application, Ser. No. 63/631,703, filed on Apr. 9, 2024, entitled “Beer Tap Socket.” The subject matter disclosed in that Provisional Application is hereby expressly incorporated into the present Application in its entirety.

### TECHNICAL FIELD AND SUMMARY

The present disclosure relates to draft beer tap, or like pressurized fluid dispenser, systems and, particularly, to a beer tap socket capable of tightening or loosening a nut threaded onto a beer tap shank.

Bars and restaurants that serve draft beer often offer a selection or variety of such beers. Typically, each variety of beer is dispensed from a separate keg. Each keg is fluidly coupled to an individual beer tap configured to dispense the beer into a cup or glass. Because these bars or restaurants serve multiple draft beers, multiple kegs are attached to multiple corresponding beer taps. Typically, these multiple beer taps are lined side-by-side on a beer tap rail with one tap corresponding to one keg of beer.

Behind each beer tap, on the beer tap rail, is a dispensing system that draws the beer from the keg, through the tap, and into the glass. The keg is, typically (but not always), stored in a remote location from the beer tap rail. A coupler is attached to the keg, as well as a carbon dioxide tank. The carbon dioxide helps push the beer from the keg and out through a beer line to the tap. The other end of the beer line, opposite the coupler and keg, is a beer shank. The beer shank is an adapter that attaches to the beer tap rail or other beer tap support structure and connects the beer line, hose, or tube to the tap. One end of the beer shank includes a coupler that attaches the beer line to the beer shank. The opposite end of the beer shank includes a nut and collar that sandwiches the rail in-between for securing the beer tap to the rail. Typically, the beer shank is tubular with an outer threaded surface to receive the nut and collar. The nut is, typically, located inside the rail, while the collar is located exterior of the rail, adjacent the beer tap. A handle is attached to the tap allowing selective dispensing of the beer. Pulling on the handle opens the tap, while pushing on it, or through bias, moves the handle back, closing the tap.

An issue that arises after constant movement of the handle on the tap is that the nut holding the tap onto the rail can loosen. This is especially the case with a beer tap rail composed of multiple taps having their handles constantly moved back and forth. This requires the nut inside the beer tap rail to be retightened on the beer shank. This is commonly accomplished using a shank wrench. It can be, however, a struggle to access all of the beer shanks within a rail using a simple thin wrench.

This problem is exacerbated because the rear side or inside of the beer tap rail can often be difficult to access. Such beer tap rails are often located adjacent a wall or do not have rear access to the shanks. In many instances, it becomes difficult to see the particular shank that requires tightening, let alone getting the wrench in proper position on the nut to tighten it.

Accordingly, an illustrative embodiment of the present disclosure provides a beer tap socket configured to engage and tighten a nut installed on a fluid tube shank installed on a tap rail. The tap socket includes a longitudinally extending body, a cavity, a slot, and a first opening. The cavity is located within the longitudinally extending body. The slot extends from an exterior of the longitudinally extending body to the cavity. The first opening is located at an end of the longitudinally extending body. The first opening is in communication with the cavity. A periphery of the first opening defines a plurality of facets. Each facet of the plurality of facets is angled with respect to an adjacent facet of the plurality of facets. The slot is configured to receive at least a portion of the fluid tube shank. The plurality of facets is configured to correspond to a plurality of wall surfaces on the nut and the plurality of facets engages the plurality of wall surfaces so that when the tap socket is rotated, the tap socket rotates the nut.

In the above and other illustrative embodiments, the beer tap socket may further comprise: the cavity extends to the first opening and a second opening located on the tap socket opposite the first opening, and wherein at least one of the first opening and the second opening is configured to receive the fluid tube shank; the slot extends to the first opening and a second opening located on the tap socket opposite the first opening, and wherein the slot is configured to receive the fluid tube shank; a first facet of the plurality of facets defines at least a portion of both the first opening and the cavity of the tap socket; a second facet of the plurality of facets defines at least a portion of both the first opening and the cavity of the tap socket. the plurality of facets includes at least six facets; a number of the plurality of facets is selected from the group consisting of at least two facets, three facets, four facets, five facets, six facets, seven facets, and eight facets; the longitudinally extending body of the tap socket includes at least one handle that extends from the longitudinally extending body of the tap socket; the longitudinally extending body of the tap socket includes a first handle that extends from the longitudinally extending body of the tap socket and a second handle that extends from the longitudinally extending body of the tap socket opposite the first handle; a plurality of wrench surfaces located at an end of the tap socket opposite the first opening; a number of wrench surfaces of the plurality of wrench surfaces is selected from the group consisting of at least two wrench surfaces, three wrench surfaces, four wrench surfaces, five wrench surfaces, six wrench surfaces, seven wrench surfaces, and eight wrench surfaces; a plurality of wrench surfaces located on the longitudinally extending body of the tap socket; each facet of the plurality of facets need not be configured to engage each wall surface of the plurality of wall surfaces of the nut; the plurality of facets located at the first opening does not extend to a second opening located on the tap socket opposite the first opening; and the slot and the cavity both extend a length of the tap socket from the first opening to a second opening located opposite the first opening.

Another illustrative embodiment of the present disclosure provides a beer tap socket configured to engage and tighten a nut installed on a fluid tube shank installed on a tap rail. The tap socket includes a body, a cavity, a slot, and a first opening. The cavity is located within the body. The slot extends from an exterior of the body to the cavity. The first opening is located in the body. The first opening is in communication with the cavity. At least a portion of a periphery of the cavity defines a plurality of facets. The slot is configured to receive at least a portion of the fluid tube shank. The plurality of facets is configured to correspond to a plurality of wall surfaces on the nut.

In the above and other illustrative embodiments, the beer tap socket may further comprise: the body being a longitudinally extending body; the first opening being located at an end of the body; and each facet of the plurality of facets is angled with respect to an adjacent facet of the plurality of facets, and wherein the tap socket is configured to be rotated to rotate the nut.

Another illustrative embodiment of the present disclosure provides a method of tightening a nut threaded on a fluid tube shank installed on a tap rail. The method comprises the steps of: providing a tap socket that includes a body, a cavity located within the body, a slot extending from an exterior of the body to the cavity, a first opening in the body wherein the first opening is in communication with the cavity; at least a portion of a periphery of the cavity defining a plurality of facets, and wherein the plurality of facets is configured to correspond to a plurality of wall surfaces on the nut; the slot and the cavity receiving at least a portion of the fluid tube shank; aligning and engaging the plurality of facets with the plurality of wall surfaces on the nut; and rotating the tap socket to rotate the nut.

Additional features and advantages of the beer tap socket will become apparent to those skilled in the art upon consideration of the following detailed descriptions of carrying out this beer tap socket as presently perceived.

### BRIEF DESCRIPTION OF THE DRAWINGS

The concepts described in the present disclosure are illustrated by way of example and not by way of limitation in the accompanying figures. For simplicity, and clarity of illustration, elements illustrated in the figures are not necessarily drawn to scale. For example, the dimensions of some elements may be exaggerated relative to other elements for clarity. Further, where considered appropriate, reference labels may be repeated among the figures to indicate corresponding or analogous elements.

FIG. 1 is a perspective view of an illustrative beer tap rail;

FIG. 2 is a front view of a portion of the beer tap rail;

FIG. 3 is a rear side perspective view of the beer tap rail with tap handles extending upwardly from the front of the beer tap rail;

FIG. 4 is a perspective rear view of a portion of the beer tap rail with multiple shanks secured to the beer tap rail via nuts;

FIG. 5 is another detail rear perspective view of the inside of the beer tap rail with an illustrative embodiment of the tap socket engaging the nut;

FIG. 6 is a perspective isolated view of the tap socket engaging the nut, as well as a separate view of the nut that threads onto the shank;

FIG. 7 is an isolated perspective view of a tap socket;

FIG. 8 is another perspective view of the tap socket;

FIG. 9 is an illustrative perspective side view of a portion of a simulated beer tap rail with a tap socket located over the shank and engaging a nut;

FIG. 10 is a detail side view of a portion of the simulated beer tap rail with the tap socket positioned on the nut and over the shank;

FIG. 11 is an end view of the tap socket showing the configuration of the facets;

FIG. 12 is a side view of the tap socket;

FIG. 13 is an end view of another illustrative embodiment of the tap socket;

FIG. 14 is a side view of the embodiment of the tap socket of FIG. 13;

FIG. 15 is perspective view of another illustrative embodiment of the tap socket;

FIG. 16 is an end perspective view of the embodiment of the tap socket of FIG. 15; and

FIG. 17 is a side view of the embodiment of the tap socket of FIG. 15.

Corresponding reference characters indicate corresponding parts throughout the several views. The exemplification set out herein illustrates embodiments of the beer tap socket, and such exemplification is not to be construed as limiting the scope of the beer tap socket in any manner.

### DETAILED DESCRIPTION OF THE DRAWINGS

The figures and descriptions provided herein may have been simplified to illustrate aspects that are relevant for a clear understanding of the herein described devices, systems, and methods, while eliminating, for the purpose of clarity, other aspects that may be found in typical devices, systems, and methods. Those of ordinary skill may recognize that other elements and/or operations may be desirable and/or necessary to implement the devices, systems, and methods described herein. Because such elements and operations are well known in the art, and because they do not facilitate a better understanding of the present disclosure, a discussion of such elements and operations may not be provided herein. However, the present disclosure is deemed to inherently include all such elements, variations, and modifications to the described aspects that would be known to those of ordinary skill in the art.

An illustrative embodiment of the present disclosure provides a beer tap socket that is configured to tighten a nut installed on a beer shank that is itself installed on a beer tap rail or other like structure. The tap socket is configured to fit around an installed shank and beer tube, depending on the length of the shank, and engage the nut. By rotating the tap socket, its grip on the nut rotates it, thereby, tightening or loosening it, as needed. The tap socket may also be longitudinally extending and configured to be used even if the nut/shank to be tightened is not fully visible by a user. The tap socket may be held in the hand, which can then reach into the rail. A slot in the tap socket allows it to fit onto the shank from the side. The tap socket is then moved longitudinally along the shank toward the nut threaded on the shank for purposes of tightening or loosening same.

In an illustrative embodiment, at least a portion of the tap socket, particularly its end, can have multiple angled wall surfaces or facets that correspond to several of the wall surfaces or facets on the nut. When the tap socket fits onto the nut, the facets of the tap socket align with several of the walls of the nut. The slot, illustratively, extends the length of the tap socket and into its center so the tap socket need not align or engage with every nut wall to tighten it. If the nut is composed of a hexagonally walled outer surface, for example, the tap socket can engage at least a portion of all 6 walls. In other embodiments, however, the tap socket facets need only engage 2, 3, 4, or 5 corresponding walls to rotate the nut. Thus, not all six walls are required to be engaged to rotate the nut. The result is the ability to have a socket that can substantively surround the shank from the side, move axially to engage the nut, and rotate same. Illustratively, handles can extend from either one or both sides of the tap socket transverse to its axis of rotation. These handles provide a gripping and leverage feature to help rotate the tap socket and hence the nut threaded on the shank.

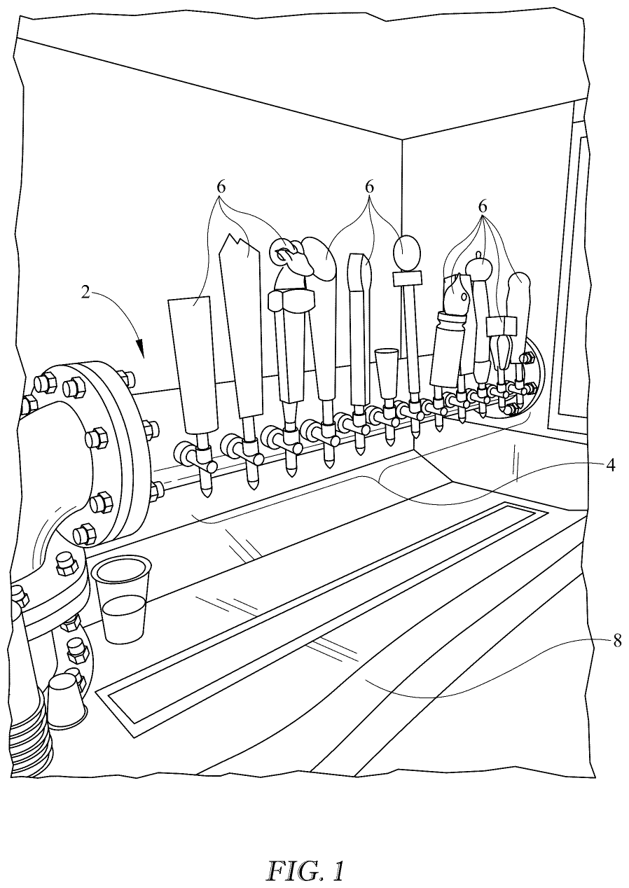

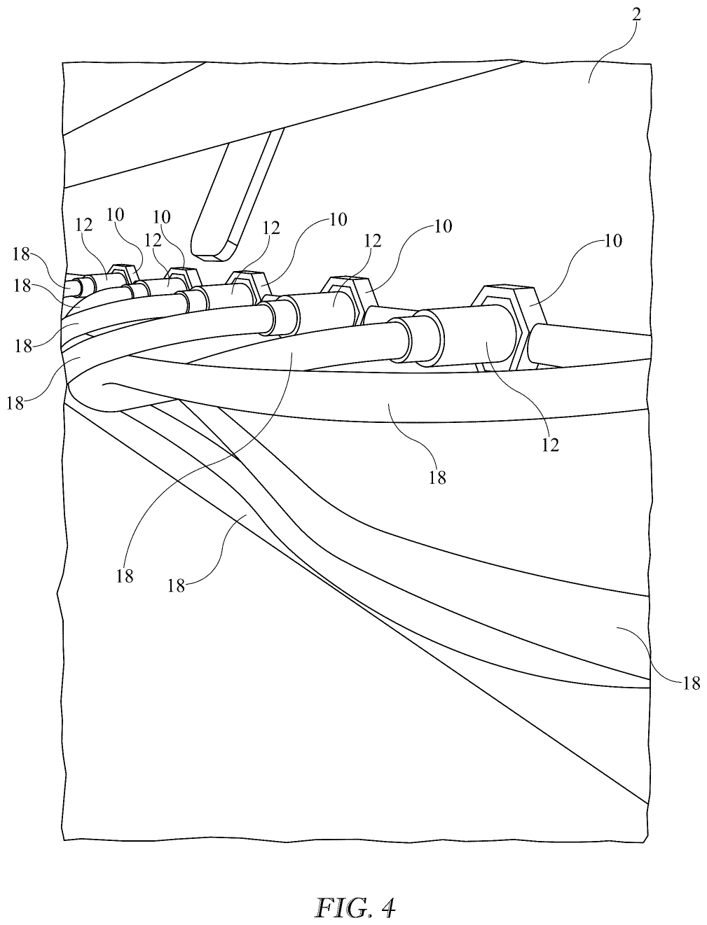

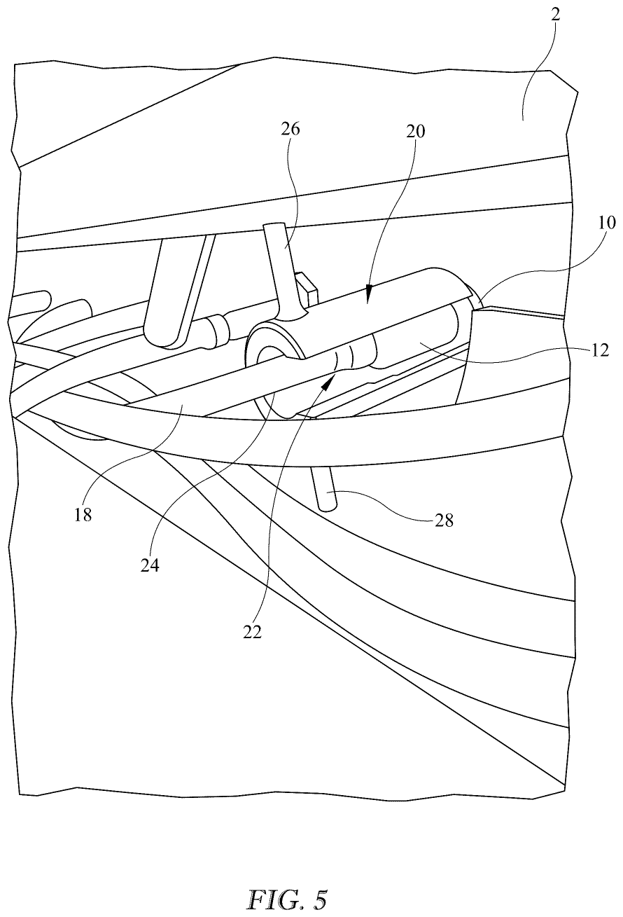

A perspective view of an illustrative beer tap rail 2 is shown in FIG. 1. Extending from beer tap rail 2 is a plurality of beer taps 4. Each beer tap 4 includes a handle 6 as illustratively shown. Each handle 6 is pulled forward with respect to bar top 8 to dispense beer. Either through bias or motive force, handles 6 are pushed back in the opposite direction to close beer tap 4. Each time beer tap 4 dispenses, some level of stress (even de minimis) is exerted thereon. This constant back and forth motion of handle 6, in combination with the beer dispensing from beer tap 4, causes it to loosen over time. By loosening, what happens is nut 10, threaded on shank 12 (see, FIG. 4), within beer tap rail 2, loosens, causing some axial rotation of beer tap 4 with respect to beer tap rail 2.

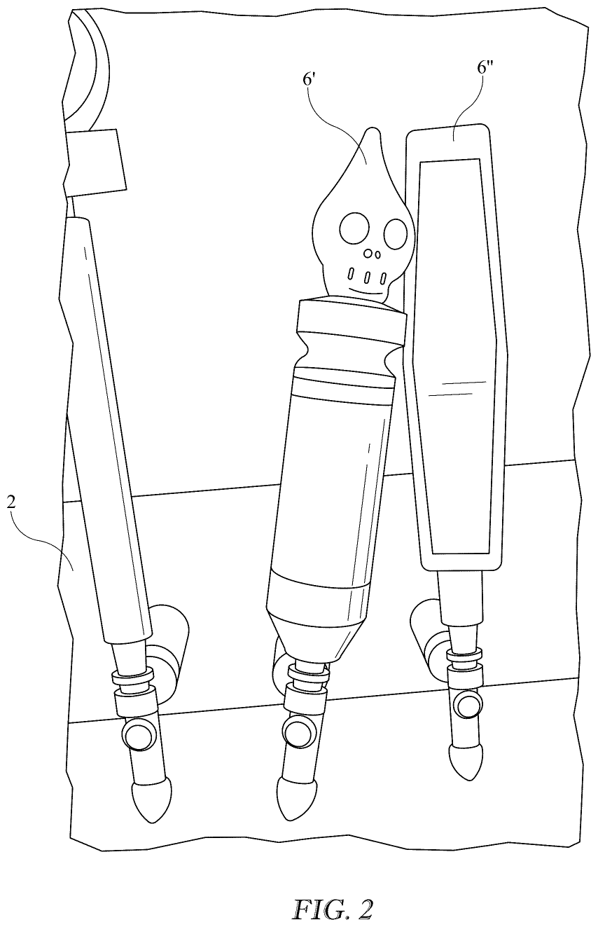

A front view of beer tap rail 2, showing handle 6′ axially rotated sufficient to interfere with an adjacent handle 6″, is shown in FIG. 2. This configuration of handle 6′ indicates that beer tap 4, which is fluidly coupled to shank 12 (see, FIG. 4), has loosened by virtue of nut 10 (see, also, FIG. 4) loosening on shank 12. This is a common problem with beer tap rails, such as beer tap rail 2, having multiple taps located thereon.

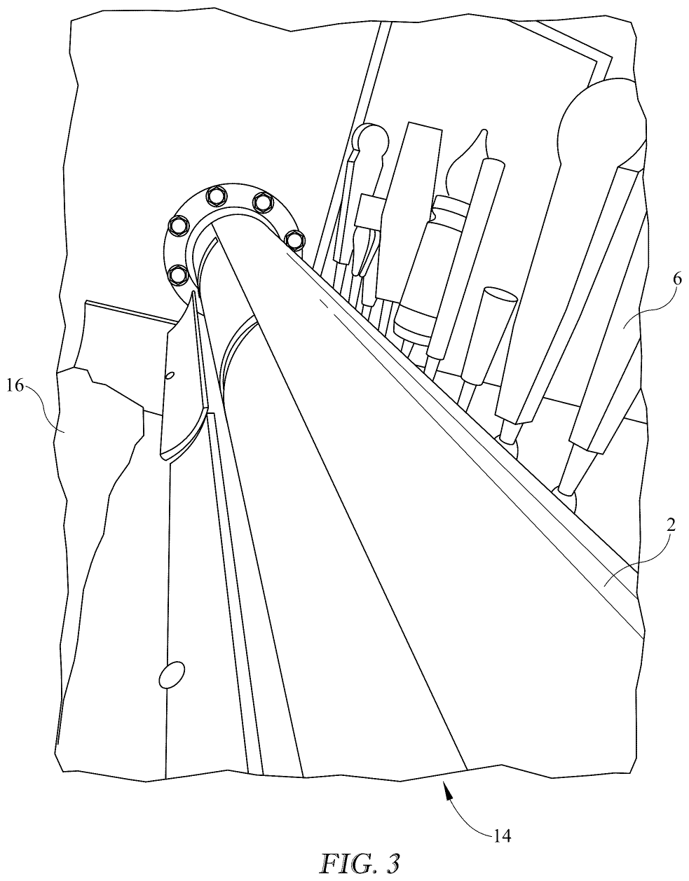

A rear side perspective view of beer tap rail 2, with tap handles 6 extending upwardly from the front of beer tap rail 2, is shown in FIG. 3. This view depicts rear access 14 to beer tap rail 2. Slightly spaced apart from rear access 14 of beer tap rail 2 is back wall 16. This view demonstrates a lack of clearance that can exist between rear access 14 of beer tap rail 2 and back wall 16. The net effect is difficulty accessing shanks 12 and, consequently, nut 10, in order to tighten shank 12 onto beer tap rail 2.

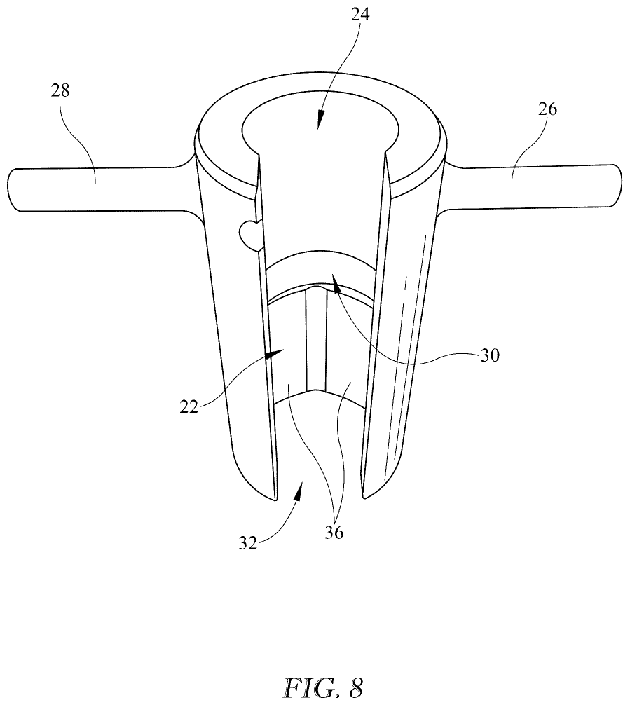

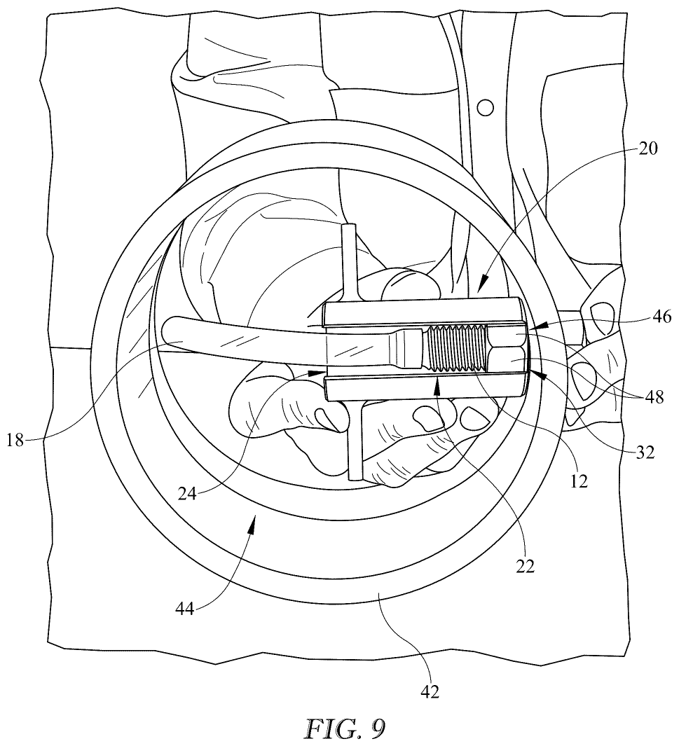

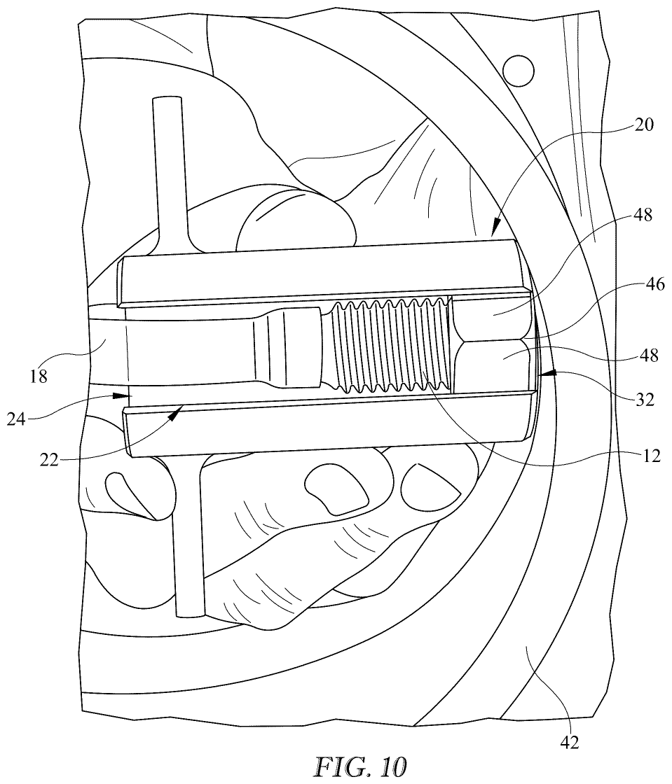

In some instances, a beer tap rail is located so close to a back wall and has no rear access that it must be accessed at the end thereof (see FIGS. 9 and 10). Regardless of configuration, often, accessing shank 12, within the beer tap rail 2, is difficult.

A perspective rear view of a portion of beer tap rail 2, with multiple shanks 12 secured to beer tap rail 2, via nuts 10, are shown in FIG. 4. Each shank 12 is coupled to a fluid tube 18 that leads to a beer keg (not shown). Fluid tubes 18 deliver the beer from the keg to beer tap 4 through shank 12. It can be appreciated from this view how accessing nuts 10 on each of shanks 12, inside beer tap rail 2, can be a challenging task. Depending on the configuration of beer tap rail 2, these shanks and nuts may not even be visible, but rather, only accessible by feel with hand and arm.

Another detail rear perspective view of the inside of beer tap rail 2 is shown in FIG.

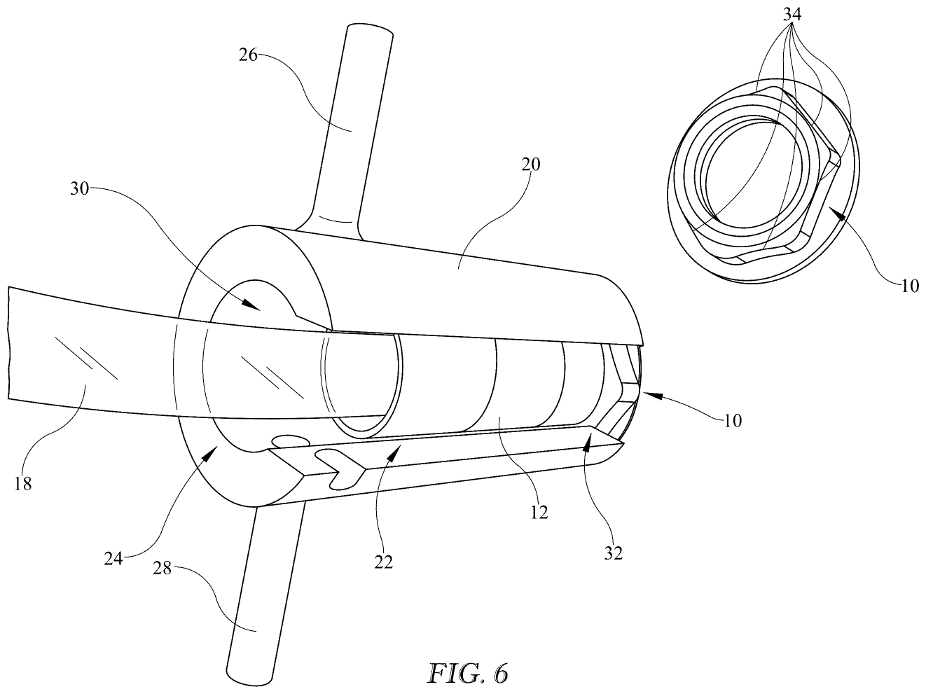

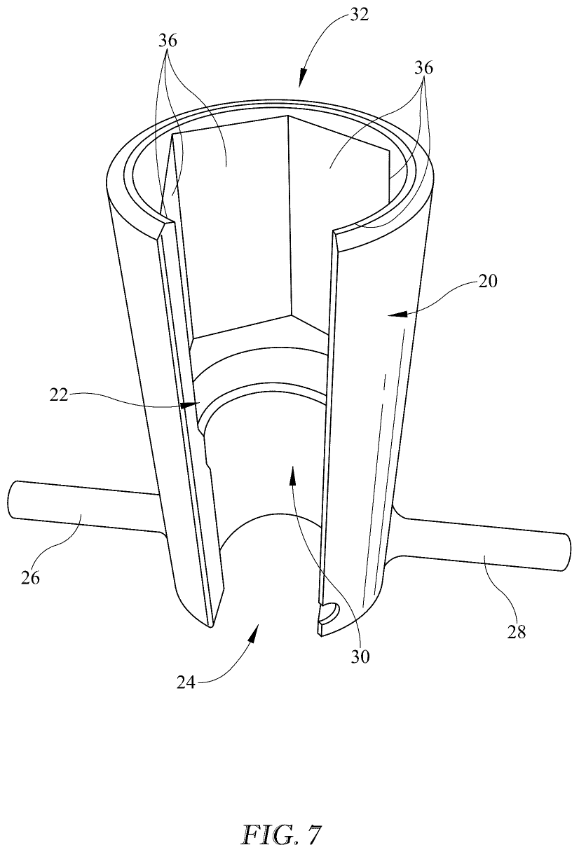

5. A distinction here is that a tap socket 20 is positioned about shank 12 and engageable with nut 10. Slot 22 of tap socket 20, along with opening 24, are sized to receive shank 12 and fluid tube 18. This allows tap socket 20 to be fitted onto nut 10 by placing it laterally with respect to shank 12 and fluid tube 18 and moving tap socket 20 sideways to receive shank 12 and fluid tube 18. Because of the length of tap socket 20, it can be placed over shank 12 and fluid tube 18 from the side and then move axially to engage nut 10. In some instances, this action can be accomplished without seeing the particular tap socket or nut being adjusted. It can be done by feel. This is why tap socket 20 has a longitudinally extending cavity 30 therein (see, FIG. 6). Once tap socket 20 is positioned about shank 12 and nut 10, rotating tap socket 20 rotates nut 10, thereby tightening or loosening it, depending on the direction tap socket 20 is rotated. It is further appreciated that tap socket 20 includes a plurality of angled facets 36 (see, FIG. 7) that engage corresponding facets or walls 34 on nut 10 (see, FIG. 6), so when tap socket 20 rotates, so too does nut 10. Handles 26 and 28 can extend laterally from the longitudinal extent of tap socket 20. Handles 26 and 28 can be used for a gripping structure and provide leverage to help the user rotate tap socket 20 in order to rotate nut 10.

A perspective isolated view of tap socket 20 engaging nut 10, with a separate view of nut 10, as well, is shown in FIG. 6. With tap socket 20 positioned around shank 12, fluid tube 18, and on nut 10, this view further demonstrates how slot 22 extends longitudinally the length of tap socket 20, is sized to receive shank 12, and, if need be, receive fluid tube 18. Because shank 12 and fluid tube 18 are longitudinal extending, they can serve as a reference structure for tap socket 20. When the appropriate shank is identified, even just by feel and not necessarily visually, tap socket 20 can be placed adjacent shank 12 and rotated until shank 12 is positioned adjacent slot 22. At that point, tap socket 20 can be moved transversely with respect to its longitudinal extent so that shank 12 and fluid tube 18, if need be, fits within cavity 30 of tap socket 20. Fluid tube 18 can extend out of opening 24 of tap socket 20, while tool opening 32 of tap socket 20, can fit about at least a plurality of facets or walls 34 of nut 10. It is appreciated that tap socket 20 does not need to fully surround nut 10 or have corresponding facets that engage every facet or wall on nut 10. As long as at least two facets or walls are engaged by tap socket 20, it can rotate nut 10.

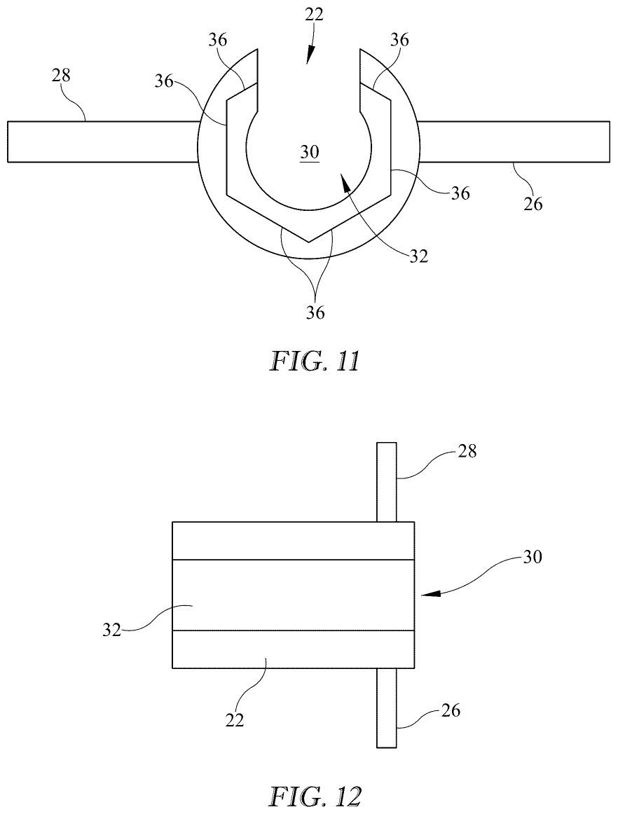

An isolated perspective view of tap socket 20 is shown in FIG. 7. This view shows tool opening 32 located opposite of opening 24. Here, facets 36, extending to tool opening 32, are sized and configured to correspond to and engage facets 34 of nut 10. In the illustrative embodiment, there are six facets 36 forming a hexagonal-type shape about the periphery of cavity 30 and terminating at slot 22 (see, FIG. 11). It is appreciated (see, also, FIG. 11) that facets 36, that are adjacent slot 22, are smaller than the other facets 36. This means that a portion of two facets or walls 34, on nut 10, will, to some extent, not be fully engaged by all facets 36. However, with the other facets or walls 34 engaged by corresponding facets 36 of tap socket 20, there is sufficient engagement between facets 36 of tap socket 20 and facets or walls 34 of nut 10 for purposes of rotating same.

Another utility of the facets 36 of tap socket 20 is once shank 12 is positioned within cavity 30, and tap socket 20 pushed down so tool opening 32 engages nut 10, tap socket 20 can be rotated as necessary so that facets 36 engage facets 34. With that engagement, rotating tap socket 20 will rotate nut 10. It will be appreciated by the skilled artisan upon reading this disclosure that the configuration of tap socket 20 does not necessarily require visual identification of shank 12 in order to insert same within slot 22 and, hence, cavity 30 of tap socket 20. This view also shows handles 26 and 28 extending laterally from the longitudinal axis of tap socket 20 to assist in rotating tap socket 20 about its axis, as needed.

Another perspective view of tap socket 20 is shown in FIG. 8. Depicted here is opening 24 and slot 22 leading to cavity 30. Facets 36 are also shown formed at least partially along the longitudinal extent of tap socket 20 and terminating at tool opening 32. Laterally extending handles 26 and 28 are shown exterior of cavity 30.

An illustrative perspective side view of a simulated beer tap rail 42, which is a fully circular tube, is shown in FIG. 9. Here, a shank 12, with fluid tube 18 extending therefrom, is located within space 44 of beer tap rail 42. In this example, and in contrast to beer tap rail 2, there is no rear access 14. Instead, access to shank 12 is accomplished from entering the side of beer tap rail 42, along its longitudinal axis, as FIG. 9 depicts. Nut 46, similar to nut 10, is threaded onto corresponding outer threads of shank 12. It is appreciated that shank 12 will engage a beer tap exterior of beer tap rail 42, with same sandwiched between a collar and nut 46. Despite this different configuration for beer tap rail 42, and its means of access, tap socket 20 can be inserted within space 44 from the side, and slot 22 can still receive shank 12, fluid tube 18, and nut 46. By sliding tool opening 32 onto nut 46, facets or walls 48 (like facets or walls 34 on nut 10) will abut corresponding facets 36 within cavity 30 of tap socket 20. It is appreciated that by extending tap socket 20 into space 44 from the side of beer tap rail 42, tap socket 20 just needs to be placed adjacent shank 12 and moved until shank 12 fits into slot 22 and positions within cavity 30. It is further appreciated that this can be accomplished by feel and does not necessarily require visual alignment between tap socket 20 and shank 12. This can have utility when there are several shanks and fluid tubes located along the longitudinal extent of beer tap rail 42 and the particular shank and nut requiring access is somewhere in the middle that cannot be seen from the side of beer tap rail 42.

A detail view of a portion of beer tap rail 42, with tap socket 20 positioned on nut 46 and shank 12, is shown in FIG. 10. This view further demonstrates how tool opening 32 of tap socket 20, with facets 36 (see, also, FIG. 8) extending thereto, engage corresponding facets or walls 48 on nut 46 for purposes of rotating same, to tighten or loosen. With tap socket 20 having illustrative slot 22 extending the full length of tap socket 20, it can be laterally positioned about shank 12 and fluid tube 18 to assist in positioning tap socket 20 correctly about nut 46.

End and side views of tap socket 20 are shown in FIGS. 11 and 12, respectively. FIG. 11, for example, shows illustrative configuration of facets 36 extending to tool opening 32. This view also demonstrates how slot 22 extends into cavity 30, which receives shank 12. Such structures, along with handles 26 and 28, are shown in the side view of FIG. 12, as well.

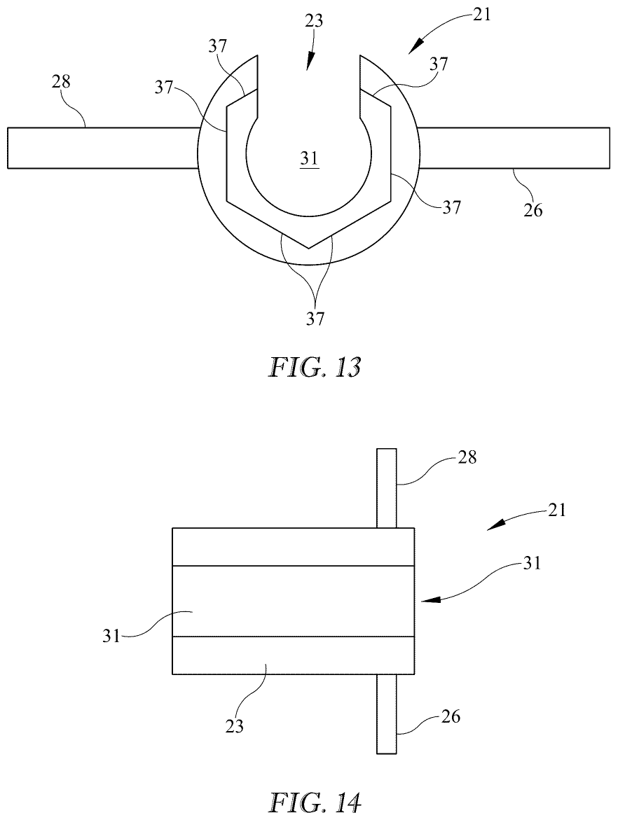

End and side views of tap socket 21 are shown in FIGS. 13 and 14, respectively. Tap socket 21 is substantively similar to that of tap socket 20 except that slot 23 and cavity 31 are different sizes than and slot 22 and cavity 30, respectively. Likewise, facets 37 form a 1 inch hexagonal shape rather than a 1⅛ inch hexagonal shape like that shown with tap socket 20. This demonstrates that the same tap socket can be formed having different dimensions. It will be appreciated by the skilled artisan upon reading this disclosure that other dimensions that differ from that shown in FIGS. 11-14 can be employed and are within the scope of this disclosure.

Another illustrative embodiment of the present disclosure provides a tap socket that is also configured to engage the nut threaded onto the beer house shank. This alternative embodiment, however, includes wrench flats located on the tap socket that wrench jaws can engage to turn the tap socket. These wrench flats can be positioned in triangular, quadrilateral, hexagonal, octagonal, or other like configuration that can serve as gripping surfaces for the wrench jaws. They can grip onto the wrench flats and rotate the tap socket to either tighten or loosen the nut. It is appreciated that such wrench flats can be used in conjunction with or in alternative to the handles shown in the other embodiments.

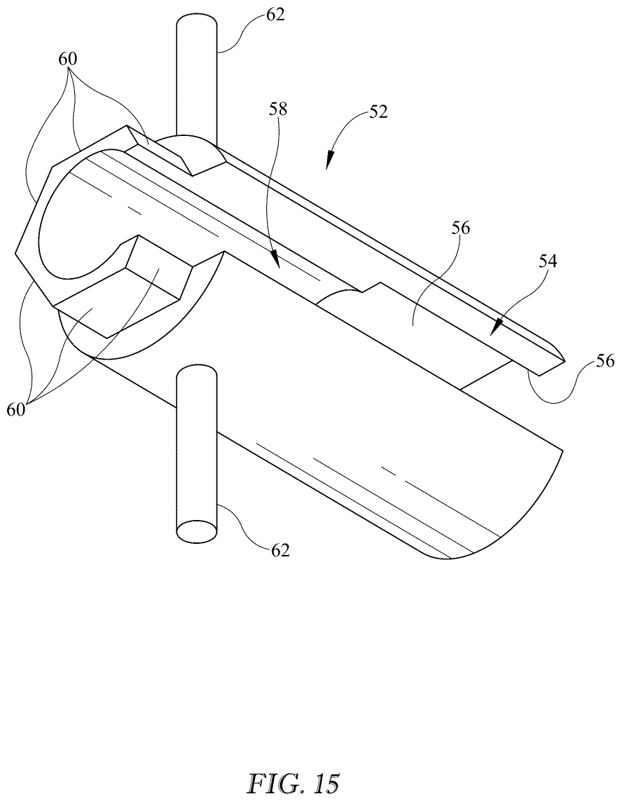

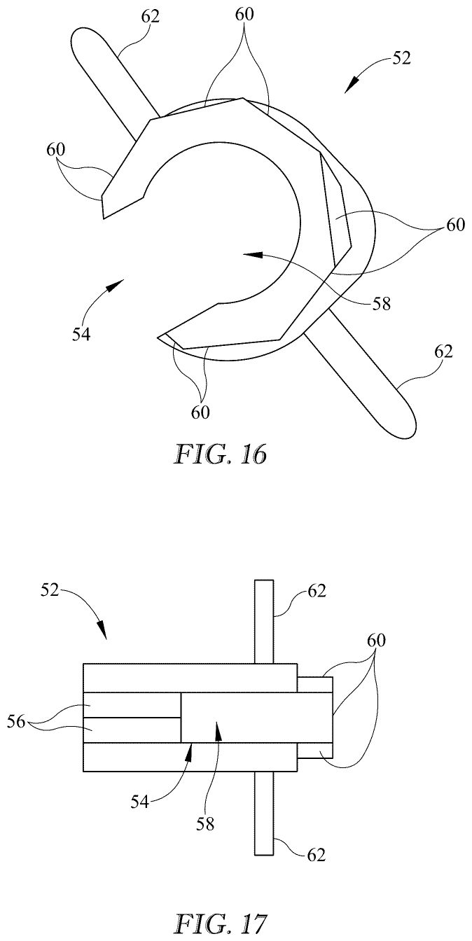

Perspective views of tap socket 52 are shown in FIGS. 15 and 16. The view in FIG. 15 shows tap socket 52 having a similar or same slot 54, with facets 56 surrounding cavity 58, similar to that of tap sockets 20 and 21. The embodiment of tap socket 52, however, further includes one or more wrench flats 60, illustratively, located on an end of tap socket 52, as shown. It is appreciated that the location of wrench flats can be anywhere on the body of tap socket 52, not just at a far end. For example, the wrench flats 60 may be located in the middle of tap socket 52.

The end perspective view of tap socket 52 is shown in FIG. 16. Here, the plurality of wrench flats 60 is shown to be in a partially octagonal arrangement that can be sized to receive wrench jaws of a character adapted to grip onto any pair of wrench flat 60 surfaces. Again, the number of wrench flats 60 are illustrative. More or fewer can be incorporated onto tap socket 52 as will be appreciated by the skilled artisan upon reading this disclosure. Also shown in FIGS. 15 and 16 are handles 62 that extend from tap socket 52 similar to tap sockets 20 and 21. It is also appreciated that such handles 62 may be eliminated completely. Alternatively, one handle may suffice in certain situations.

A side view of tap socket 52 is shown in FIG. 17. Here, slot 54 extends the line of tap socket 52 similar to tap sockets 20 and 21. Wrench flats 60 are, illustratively, shown at one end of tap socket 52 opposite facets 56. Illustratively, wrench flats 60 can form a narrower body diameter than the other portions of tap socket 52, as shown. In other embodiments, wrench flats 60 can form a wider body diameter. Again, it is appreciated that such wrench flats 60 can be located anywhere on tap socket 52, including, for example, adjacent facets 56.

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features. It should also be appreciated that any subject matter disclosed in this non-provisional patent application that may differ from the priority application, the disclosure from this non-provisional patent application controls.

What is claimed:

1. A tap socket configured to engage and tighten a nut installed on a fluid tube shank installed on a tap rail, the tap socket comprising:
a longitudinally extending body;
a cavity located within the longitudinally extending body;
a slot that extends from an exterior of the longitudinally extending body to the cavity; and
a first opening at an end of the longitudinally extending body;
wherein the first opening is in communication with the cavity;
wherein a periphery of the first opening defines a plurality of facets;
wherein each facet of the plurality of facets is angled with respect to an adjacent facet of the plurality of facets;
wherein the slot is configured to receive at least a portion of the fluid tube shank; and
wherein the plurality of facets is configured to correspond to a plurality of wall surfaces on the nut and the plurality of facets engages the plurality of wall surfaces so that when the tap socket is rotated the tap socket rotates the nut.

2. The tap socket of claim 1, wherein the cavity extends to the first opening and a second opening located on the tap socket opposite the first opening, and wherein at least one of the first opening and the second opening is configured to receive the fluid tube shank.

3. The tap socket of claim 1, wherein the slot extends to the first opening and a second opening located on the tap socket opposite the first opening, and wherein the slot is configured to receive the fluid tube shank.

4. The tap socket of claim 1, wherein a first facet of the plurality of facets defines at least a portion of both the first opening and the cavity of the tap socket.

5. The tap socket of claim 4, wherein a second facet of the plurality of facets defines at least a second portion of both the first opening and the cavity of the tap socket.

6. The tap socket of claim 1, wherein the plurality of facets includes at least six facets.

7. The tap socket of claim 1, wherein a number of the plurality of facets is selected from the group consisting of at least two facets, three facets, four facets, five facets, six facets, seven facets, and eight facets.

8. The tap socket of claim 1, wherein the longitudinally extending body of the tap socket includes at least one handle that extends from the longitudinally extending body of the tap socket.

9. The tap socket of claim 1, wherein the longitudinally extending body of the tap socket includes a first handle that extends from the longitudinally extending body of the tap socket and a second handle that extends from the longitudinally extending body of the tap socket opposite the first handle.

10. The tap socket of claim 1, further comprising a plurality of wrench surfaces located at an end of the tap socket opposite the first opening.

11. The tap socket of claim 10, wherein a number of wrench surfaces of the plurality of wrench surfaces is selected from the group consisting of at least two wrench surfaces, three wrench surfaces, four wrench surfaces, five wrench surfaces, six wrench surfaces, seven wrench surfaces, and eight wrench surfaces.

12. The tap socket of claim 1, further comprising a plurality of wrench surfaces located on the longitudinally extending body of the tap socket.

13. The tap socket of claim 1, wherein the each facet of the plurality of facets need not be configured to engage each wall surface of the plurality of wall surfaces of the nut.

14. The tap socket of claim 1, wherein the plurality of facets located at the first opening does not extend to a second opening located on the tap socket opposite the first opening.

15. The tap socket of claim 1, wherein the slot and the cavity both extend a length of the tap socket from the first opening to a second opening located opposite the first opening.

16. A tap socket configured to engage and tighten a nut installed on a fluid tube shank installed on a tap rail, the tap socket comprising:
a body;
a cavity located within the body;
a slot that extends from an exterior of the body to the cavity;
a first opening in the body;
wherein the first opening is in communication with the cavity;
wherein at least a portion of a periphery of the cavity defines a plurality of facets;
wherein the slot is configured to receive at least a portion of the fluid tube shank; and
wherein the plurality of facets is configured to correspond to a plurality of wall surfaces on the nut.

17. The tap socket of claim 16, wherein the body is a longitudinally extending body.

18. The tap socket of claim 16, wherein the first opening is located at an end of the body.

19. The tap socket of claim 16, wherein each facet of the plurality of facets is angled with respect to an adjacent facet of the plurality of facets, and wherein the tap socket is configured to be rotated to rotate the nut.

20. A method of tightening a nut threaded on a fluid tube shank installed on a tap rail, the method comprising steps of:
providing a tap socket that includes a body, a cavity located within the body, a slot extending from an exterior of the body to the cavity, a first opening in the body wherein the first opening is in communication with the cavity; at least a portion of a periphery of the cavity defining a plurality of facets, and wherein the plurality of facets is configured to correspond to a plurality of wall surfaces on the nut;
the slot and the cavity receiving at least a portion of the fluid tube shank;
aligning and engaging the plurality of facets with the plurality of wall surfaces on the nut; and
rotating the tap socket to rotate the nut.
